(19) United States
(12) Patent Application Publication
(10) Pub. No.: US 2007/0259658 A1
(43) Pub. Date: Nov. 8, 2007

(54) SYSTEM AND METHOD FOR OPERATING A MOBILE STATION BASED UPON CONTEXT

(75) Inventor: Jama Bihya, La Prairie (CA)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/381,467

(22) Filed: May 3, 2006

(51) Int. Cl. H04Q 7/20

(52) U.S. Cl. 455/422.1; 455/433

(57) ABSTRACT

A context signal (108 or 110) is received by a mobile station (102). The context signal (108 or 110) is representative of an operational environment of the mobile station (102). The mobile station (102) determines the operational environment represented by the context signal (108 or 110). Based upon the operational environment, the mobile station (102) determines an action. The action alters a performance of the mobile station (102) in order to conform the performance of the mobile station (102) to the operational environment.

### FIELD OF THE INVENTION

The field of the invention relates to operating mobile stations within networks and, more specifically, to operating mobile stations in different operating environments in these networks.

### BACKGROUND OF THE INVENTION

Mobile stations operate in a number of different operating environments. For example, a user may operate a mobile station in an environment where the mobile station needs to be muted or deactivated (e.g., at a hospital or on board an airplane) so as not cause aggravation to others or so as not to possibly induce unexpected behavior in other electronic equipment. On the other hand, the mobile station may operate in environments where there are fewer operational restrictions (the user's home or office) or in still other environments where ambient noise or other factors may be a moderate concern to the mobile station user (e.g., a shopping center or train).

As a result of having to operate in a wide variety of operating environments, mobile stations frequently are manipulated by users to manually change their features. For instance, some mobile stations allow the loudness of their ringers to be manually adjusted (or totally muted). In other examples, mobile stations can be manually set to operate in a “vibrate mode” of operation for some environments and a “ringing” mode of operation for other types of operating environments. In another example, the entire mobile station can simply be manually deactivated by the user.

Although providing for manual performance characteristic adjustments, these previous approaches have proved inadequate in many situations. For instance, it can be cumbersome and inconvenient to manually adjust various controls of the mobile station as the operating environment changes. For example, a user may constantly change operating environments requiring a constant manual adjustment of the mobile station. In another example, a user may need to deactivate the mobile station while driving, creating potentially dangerous situations.

Previous approaches have also proved inadequate in situations where users forgot to change the settings of their mobile station (e.g., when the user was busy, distracted, forgetful, or even ignorant as to how to achieve the desired setting). For example, a user might enter a movie theatre and forget to put their mobile station in vibrate mode. Later, the mobile station may ring, creating embarrassment for the user and frustration for the other theatre patrons. All of the above-mentioned problems led to user frustration with the mobile station, frustration of others with the user of the mobile station, and potentially dangerous situations.

### BRIEF DESCRIPTION OF THE DRAWINGS

The above needs are at least partially met through provision of a system and method for providing context information to a mobile station described in the following detailed description, particularly when studied in conjunction with the drawings, wherein:

FIG. 1 is a block diagram of a system for determining context information and operating a mobile station according to the environment according to various embodiments of the present invention;

FIG. 2 is a flowchart of one approach for operating a mobile station according to its environment according to various embodiments of the present invention;

FIG. 3 is a flowchart of determining a performance action to take to adjust the performance of a mobile station according to various embodiments of the present invention; and

FIG. 4 is a block diagram of a mobile station according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that allow a mobile station to receive context information and the context information is automatically used to adjust the performance of the mobile station. Consequently, mobile stations may be operated according their current operational context and the performance of the mobile station can automatically be changed as this context changes. Advantageously, user frustration is significantly reduced or eliminated, the needs of others in vicinity of the mobile station are taken into account, and potentially hazardous situations are avoided.

In many of these embodiments, a context signal is received by a mobile station. The context signal is representative of an operational environment (context) of the mobile station. The mobile station determines the operational environment represented by the context signal. Based upon the operational environment, the mobile station determines an action. The action alters the performance of the mobile station in order to conform the performance of the mobile station to the operational environment.

The context signal may take a variety of forms. For instance, the context signal may have a particular frequency (e.g., a heartbeat signal) and this frequency may be associated with the operational environment of the mobile station and necessitate the performance of certain actions at the mobile station to conform to this environment.

In another example, the context signal may include information that indicates certain actions should be performed at the mobile station. In this case, further processing of the signal may be required to extract or determine this information. For example, the context signal may be a Mobile Station Muting Facilitation signal, which indicates the mobile station should be muted. In another example, the context signal may be a Temporary Communication Freeze signal, which indicates that at least some communications at the mobile station should be frozen. Moreover, the context signal may provide other types of information such as the types of communications that are not allowed to proceed at the mobile station. In this regard, the context signal may indicate that voice communications, data communications, or both voice and data communications be frozen at the mobile station.

The mobile station may determine an action to take by itself or communicate with other entities (e.g., a Home Location Register (HLR)) in order to determine the action to take. If the mobile station communicates with a HLR, the operational profile of the mobile station at the HLR (or other network entities) may be changed.

Additionally, the user may also be alerted when approaching an area where the operation of the mobile station may be altered. For instance, a warning message may be displayed at the mobile station as the mobile station approaches or enters an area where the operations of the mobile station are altered or adjusted.

Thus, approaches are provided that allow a mobile station to receive context information and use the context information to automatically adjust the performance of the mobile station to conform the operation of the mobile station to its operational environment. Consequently, user frustration with the mobile station is significantly reduced or eliminated, the needs of others in vicinity of the mobile station are taken into account, and potentially hazardous situations are eliminated.

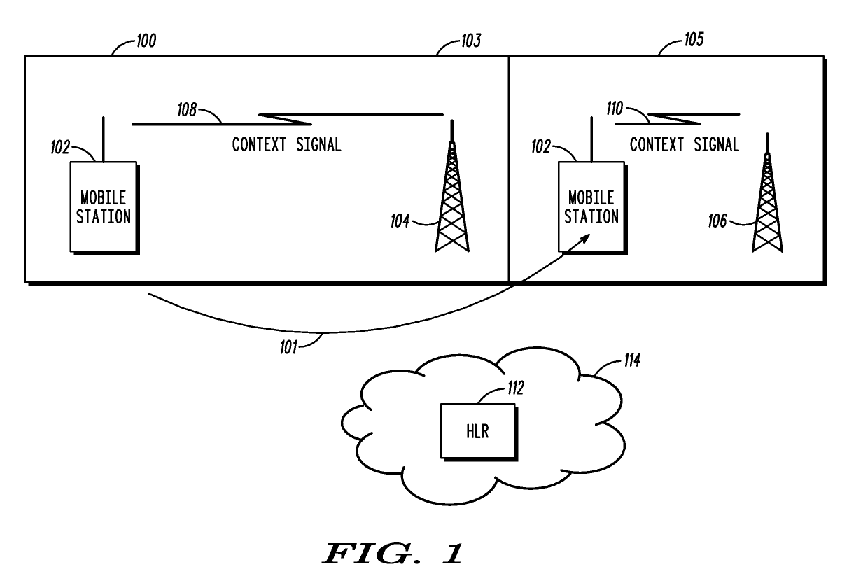

Referring now to FIG. 1, one example of a system for operating a mobile station 102 in a particular operating environment (or context) is described. The mobile station 102 moves along a path 101 and operates in different areas 103 and 105 of a network 100. The mobile station 102 communicates with a home location register (HLR) 112 that is provided in a home network 114 of the mobile station 102. It will be understood that other types of communication equipment (e.g., Visitor Location Registers (VLRs), switches, and servers) may be used in the system of FIG. 1 to allow the various components of the system to communicate with each other, and the operation of these elements is well known and understood by those skilled in the art. Consequently, these elements and their operation will not be discussed further herein.

The mobile station 102 may be any type of wireless communication device. For example, the mobile station 102 may be a cellular telephone, a pager, a personal computer, or a personal digital assistant. Other examples of mobile stations are possible.

Context sources 104 and 106 communicate with the mobile station 102 as the mobile station moves within the network 100. The context sources 104 and 106 transmit context signals 108 and 110, respectively, and may be any type of transmission device such as a radio transmitter that transmits radio frequency (RF) signals. Alternatively, the context sources 104 and 106 may be other types of transmitters that transmit other types of signals, such as optical or acoustic signals.

In one example, the context sources 104 and 106 may be watchdog devices that transmit constant heartbeat signals each having a different predetermined RF frequency. The mobile station 102 is adapted to detect these signals at the predetermined RF frequencies and associates the frequency with a particular operational environment.

In this regard, the mobile station 102 may operate in various operational environments and the particular operational environment may necessitate that certain functions at the mobile station can/cannot be performed. For example, locations where mobile stations are considered evasive/disruptive such as airplanes, hospitals, and movie theatres may be equipped with watchdog devices that cause the temporary freeze of communications with the mobile station. In other areas (schools, airports), partial communications with the mobile station 102 may be allowed. In still other areas (e.g., the home of the user), full communications with the mobile station 102 are permitted.

In one example of the operation of the system of FIG. 1, the context signal 108 or 110 is received by the mobile station 102. In this example, the context signals 108 or 110 are heartbeat signals (i.e., the context sources 104 and 106 are watchdog devices) that continuously transmit signals at different predetermined frequencies. The context signals 108 or 110 are not directed at a particular mobile station (i.e., the context signals 108 and 110 are not made as a part of any peer-to-peer communication). Instead, the context signals 108 and 110 provide generic indication that (if received) indicate that the mobile station is present in a particular area or zone 103 or 105.

As mentioned, each of the signals 108 and 110 (and, consequently each of the zones 103 and 105) is associated with a different operational environment and operation of the mobile station in that zone requires the taking of different actions at the mobile station 102 to conform the operation of the mobile station 102 to that environment. For example, reception of the context signal 108 may indicate a total communication freeze (i.e., the mobile station is in zone 103) and reception of the context signal 110 may indicate a partial communication freeze (i.e., the mobile station 102 has entered the zone 105, which is a restricted communication area).

After initially receiving the signal, the mobile station 102 determines the operational environment represented by the context signal 108 or 110. In this regard, the mobile station 102 may communicate with its home network. For instance, the mobile station 102 may determine that a heartbeat signal of a certain frequency has been received and communicate this information to its home network 114. The home network 114 updates the mobile station location and profile information (stored at the home network 114) and may send confirmation of the update to the mobile station 102.

In some approaches, the mobile station 102 warns the user that no communications or restricted communications are allowed for the user when the user is in the area having the specified context. For example, a persistent “Limited Tolerance to Mobile Communication Area” text message may be displayed at the mobile station 102. In another example, a warning light may be activated at the mobile station 102 indicating that the mobile station 102 is in a restricted area. Other examples of warning approaches and messages are possible.

Based upon the operational environment, the mobile station 102 determines if an action need be performed and, if needed, performs the action. The action alters a performance of the mobile station 102 in order to conform the performance of the mobile station 102 to the operational environment indicated by the heartbeat signal.

The mobile station 102 continuously listens for the heartbeat signals emitted by the context devices 104 and 106. As long as these heartbeat signals are received, the mobile station 102 remains in total or restricted muted mode. If the mobile station 102 does not receive a heartbeat signal for a predetermined amount of time (e.g., three cycle times), the mobile station 102 determines that it has left or is about to leave the restricted zone 105 or the total communication freeze zone 103. In this case, it sends a return to normal operating mode request message to its home network 114.

The home network 114, after receiving the request acts as if the mobile station 102 has just been activated or as if the mobile station has just entered the coverage area again. For instance, the home network 114 may send voice mail notifications to users. A “Limited Tolerance to Mobile Communications Area” warning message displayed on the mobile station may be removed, and, for example, the normal icons displayed at the mobile station 102 may be again displayed.

By comparing the location of the mobile station 102 with the location of a watchdog device, the network 100 can determine the identity of mobile stations that need to be aware of their proximity to “Limited Tolerance to Mobile Communication” zones. In this case, the network 114 may receive a message indicating that the mobile station is near one of these zones and the message may be displayed at the mobile station 102.

In other approaches, each of the context sources 104 and 106 may emit a limited set of different signals (e.g., signals at different frequencies or including embedded information) that will cause the mobile station 102, in conjunction with the HLR 112, to take appropriate actions. For example, one signal emitted by the context sources 104 and 106 may be a Voice Call Mute Zone signal, indicating that the mobile station 102 should not be able to make or receive phone calls but still can send short messages in a particular area or zone. In this case, the mobile station 102 would function as a pager.

In another example, the context sources 104 and 106 may emit a Total Communication Functions Mute signal. This signal may be processed by the HLR 112 (to determine the context indicated by the information in the signal), after the mobile station 102 has forwarded a message to the HLR 112, indicating that a temporary freeze of all communication features of the mobile station 102 should occur. The HLR 112 is updated with the profile of the subscriber in order to block incoming and outgoing voice calls and text messages. In this case, the mobile station 102 functions may still perform other functions, such as those of a handheld electronic organizer.

The home network 114 may update its mobility profile at the HLR 112 (or a visitor location register). Depending upon the profile of the user, incoming calls/text messages are forwarded to another number, to their voice mail box, or dropped. Outgoing communications with the mobile station 102 may be blocked or restricted.

After detecting the context sources 104 and 106 and communicating with the HLR 112, the mobile station 102 may warn the user that they are entering a particular zone or area. For example, the mobile station 102 may display messages to the user warning the user that they are about to enter a restricted zone 105 or are already in this restricted zone of operation. By issuing a warning, the user may have the opportunity to avoid entering or to leave the restricted area 105 if desired.

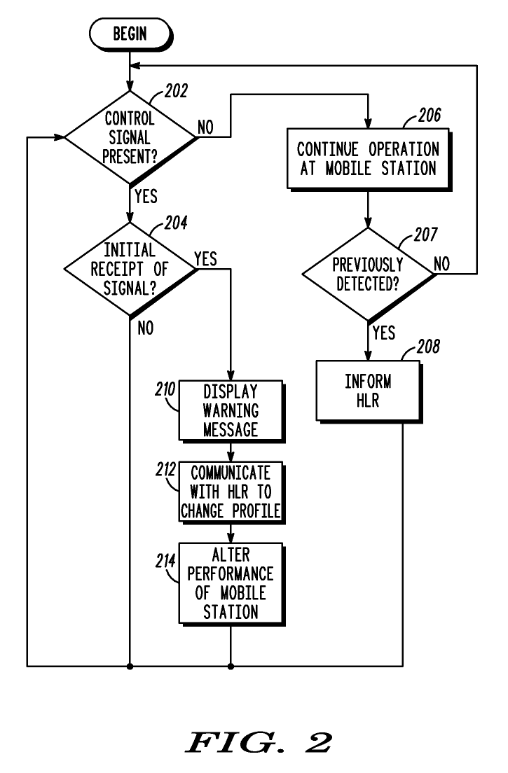

Referring now to FIG. 2, one example of an approach for operating a mobile station according to a certain operational environment is described. At step 202, it is determined whether a context signal has been received. The context signal may take any number of forms. For example, the signal may be a heartbeat signal having a certain frequency that has been emitted by a watchdog device. Alternatively, the context signal may include information (e.g., a certain bit pattern) indicating that it is a certain message type.

If the answer at step 202 is affirmative, execution continues at step 204 where it is determined whether the detection of the context signal is an initial detection. If the answer at step 204 is negative (i.e., the context signal has already been detected), execution continues at step 202 as described above. If the answer at step 204 is affirmative (i.e., the context signal is being initially detected), execution continues at step 210 where a warning message is displayed at the mobile station. At step 212, the mobile station communicates with its home location register (HLR) to change the profile of the mobile station. At step 214, performance of the mobile station is altered to conform its performance to the context in which the mobile station is operating.

If the answer at step 202 is negative (i.e., no context is detected), then execution continues at step 206 where normal operation of the mobile station proceeds. At step 207, it is determined whether a context signal had been previously detected (i.e., a context signal had been detected but has now disappeared). If the answer at step 207 is affirmative, at step 208 the mobile station informs the HLR that the mobile station is leaving the restricted mode of operation. If the answer at step 207 is negative, execution continues at step 202 as described above.

Referring now to FIG. 3, one example of an approach for altering the performance of a mobile station according to the operational environment of the mobile station is described. It will be understood that the approach taken in FIG. 3 is only one example and that other types and combinations of actions may also be performed.

At step 302, the operational environment (context) of the mobile station is determined. In this example, the operational environment may necessitate that at least some communications with the mobile station be frozen, the mobile station may be muted, or no action occurs.

If the operating environment indicates that at least some of the communications of the mobile station be frozen, at step 304, it is determined whether a partial or total freeze of communications is desired. If a partial freeze is desired, at step 306, a partial freeze of selected communications is made at the mobile station. If a total freeze is desired, at step 308, all communicates at the mobile station are frozen.

If the context determination at step 302 indicates that the mobile station be muted, at step 310, the mobile station is muted. If the context determination at step 302 indicates that no action is required, at step 312, the mobile station continues with its current operations.

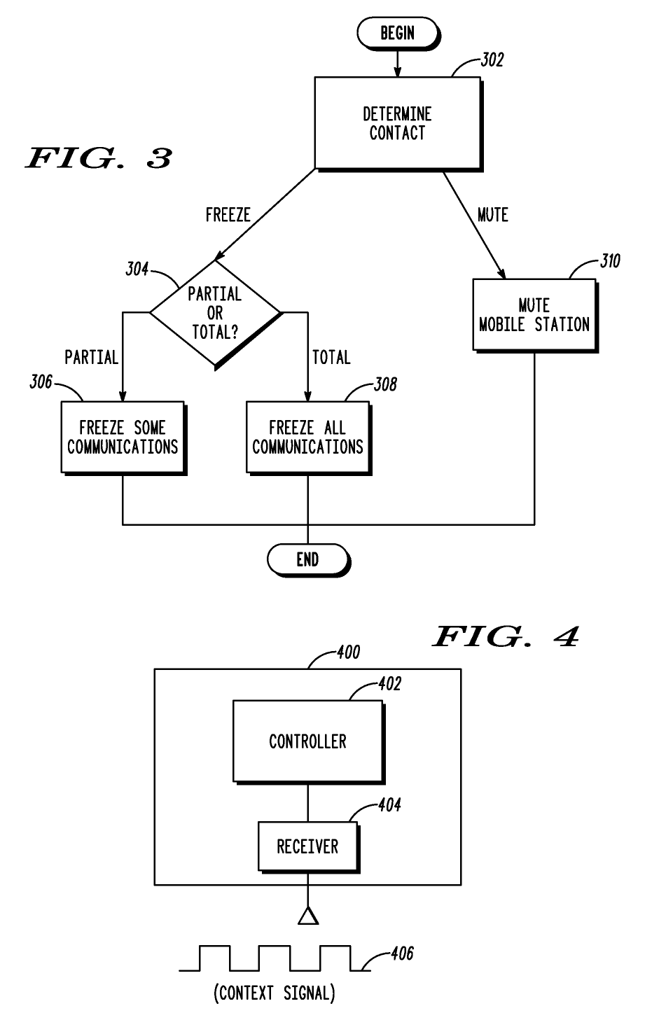

Referring now to FIG. 4, one example of a mobile station 400 is described. The mobile station 400 comprises a receiver 402 and a controller 404. The receiver 402 receives a context signal 406 and the context signal 406 is representative of an operational environment of the mobile station 400. In one approach, the context signal 406 may be a heartbeat signal emitted from a watchdog device. This heartbeat signal may be transmitted according to a certain frequency that has been associated with the operational environment of the mobile station 400. In other approaches, the context signal may include other types of information that identify the operational environment of the mobile station 400.

The controller 404 is programmed to determine the operational environment represented by the context signal 406. Based upon the operational environment, the controller 404 determines an action to take at the mobile station 400. The action potentially alters the performance of the mobile station 400 in order to conform the performance of the mobile station 400 to the operational environment.

The operational environment relate to a variety of different types of environments. For instance, the operational environment may be a working environment, an educational environment, or an entertainment environment. Other examples of environments are possible.

Thus, approaches are provided that allow a mobile station to receive context information and the context information is automatically used to adjust the performance of the mobile station. Consequently, users are provided with convenient approaches to automatically operate their mobile station according to the context the mobile station is operating. User frustration is significantly reduced or eliminated and the needs of others in vicinity of the mobile station are taken into account.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of operating a mobile station comprising:
receiving a context signal, the context signal representative of an operational environment of the mobile station;
determining the operational environment represented by the context signal; and
based upon the operational environment, determining an action to take at the mobile station, the action altering a performance of the mobile station in order to conform the performance of the mobile station to the operational environment.

2. The method of claim 1 wherein receiving a context signal comprises receiving a signal having a frequency, the frequency been associated with the operational environment of the mobile station.

3. The method of claim 1 wherein receiving a context signal comprises receiving a signal comprising information indicating the operational environment of the mobile station.

4. The method of claim 1 wherein receiving the context signal comprises receiving a mobile station muting facilitation signal.

5. The method of claim 1 wherein receiving the context signal comprises receiving a signal indicating at least a temporary communication freeze.

6. The method of claim 5 wherein the signal at least temporary freezes communications selected from a group comprising: voice communications, data communications, and voice and data communications.

7. The method of claim 1 wherein determining an action comprises communicating with a Home Location Register (HLR) to determine the action to take at the mobile station.

8. A mobile station comprising:
a receiver for receiving a context signal, the context signal representative of an operational environment of the mobile station; and
a controller coupled to the receiver, the controller being programmed to determine the operational environment represented by the context signal, and based upon the operational environment to determine an action to take at the mobile station, wherein the action alters a performance of the mobile station in order to conform the performance of the mobile station to the operational environment.

9. The mobile station of claim 8 wherein the operational environment relates, at least in part to at least one of an working environment; a educational environment; and an entertainment environment.

10. The mobile station of claim 8 wherein the context signal comprises a frequency, the frequency been associated with the operational environment of the mobile station.

11. The mobile station of claim 8 wherein the context signal comprises information indicating the operational environment of the mobile station.

12. The mobile station of claim 8 wherein the context signal comprises a mobile station muting facilitation signal.

13. The mobile station of claim 8 wherein the context signal comprises a mobile station temporary communication freeze signal.

14. A system comprising:
a context signal transmitter;
a home location register (HLR); and
a mobile station communicatively coupled to the HLR and receiving a context signal from the context signal transmitter, the context signal representative of an operational environment of the mobile station, the controller being programmed to determine the operational environment represented by the context signal, and based upon the operational environment, to determine an action to take at the mobile station, wherein the action alters a performance of the mobile station in order to conform the performance of the mobile station to the operational environment.

15. The system of claim 14 wherein the context signal comprises a frequency, the frequency been associated with the operational environment of the mobile station.

16. The system of claim 14 wherein the context signal comprises information indicating the operational environment of the mobile station.

17. The system of claim 14 wherein the context signal comprises information requesting the mobile station be muted.

18. The system of claim 14 wherein the context signal comprises information requesting a temporary freeze of all communication features of the mobile station.

19. The system of claim 14 wherein the mobile station is further programmed to exchange messages with the HLR when determining the action to take at the mobile station.
